(19) United States
(12) Patent Application Publication
(10) Pub. No.: US 2005/0278936 A1
(43) Pub. Date: Dec. 22, 2005

(54) Optoelectronic apparatus with a shielding cage, and methods for production of an optoelectronic apparatus with a shielding cage.

(76) Inventor: Nikolaus Schunk, Maxhutte-Haidhof (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/871,315

(22) Filed: Jun. 18, 2004

(51) Int. Cl. H01S 4/00

(52) U.S. Cl. 29/592.1

(57) ABSTRACT

The invention relates to an optoelectronic apparatus in which a shielding cage is integrated in a housing to reduce electromagnetic interference. The invention further relates to methods for production of an optoelectronic apparatus having a shielding cage integrated into a housing portion thereof.

The invention relates to an optoelectronic apparatus in which a shielding cage is integrated in order to reduce electromagnetic interference radiation. The invention furthermore relates to two methods for production of an optoelectronic apparatus such as this with an integrated shielding cage.

### BACKGROUND OF THE INVENTION

There is a general problem in providing electromagnetic shielding for optical transceivers and their transducer modules. The transmission component of an optical transceiver must therefore be shielded owing to the electromagnetic radiation which it emits. The receiving element of an optical transceiver must be protected against incident electromagnetic radiation, in order to minimize the influence of interference radiation on signal detection.

It is known for an external shielding plate, which is bent completely around the respective optical components, to be used for electromagnetic shielding. Furthermore, in order to reduce electromagnetic interference radiation, it is known for the modules to be inserted in an injection-molded or die-cast body, with the injection-molded body or die-cast body being composed of a conductive injection-molding or die-casting substance.

The known technical solutions are complex and costly. The use of an external shielding plate also means that additional space is required, so that the distance between the transmission module and the receiving module in an optical transceiver cannot be reduced to the desired extent, which leads to undesirable design restrictions.

There is therefore a requirement to provide a shielding for optoelectronic transducers in optical transceivers in a simple and effective manner.

### SUMMARY OF THE INVENTION

The present invention provides an optoelectronic apparatus which, as follows, has at least one optoelectronic transducer component, a leadframe on which the transducer component is arranged, a housing which at least partially surrounds the transducer component, and a wire mesh. In this case, the wire mesh is at least partially embedded in the housing, and is connected to at least one ground contact of the leadframe forming a shielding cage, in which the transducer component is located.

The invention is based on the object of providing protection against electromagnetic interference radiation by means of a wire mesh which is integrated in the respective optoelectronic apparatus and/or the respective optoelectronic module. The integration of the wire mesh in the optoelectronic apparatus results in a low-cost and space-saving solution.

According to the invention, the wire mesh is at least partially embedded in the housing and, together with the leadframe, forms a shielding cage. The shielding cage may in this case be formed directly adjacent to the transducer component. The incident and/or emitted electromagnetic radiation can thus be reduced in a very effective manner.

As a result of the choice of a wire mesh for a shielding cage, the shielding cage has only a low capacitance, so that any capacitive reaction of the wire mesh on the characteristics of the internal circuit of the optoelectronic apparatus can be ignored. This represents a further advantage of the invention.

In one preferred refinement of the invention, the wire mesh has an opening only in the area of the optical path or of the optical window in the transducer component. In the area of this opening, the housing of the optoelectronic apparatus preferably has an optical functional surface, for example a lens. In consequence, only a small unshielded opening remains in the area of the optical window; any opening in the wire mesh is reduced to an extremely small area.

The diameter or the wire thickness of the wire of the wire mesh is preferably chosen such that it is a multiple of the penetration depth of the electromagnetic radiation, with this penetration depth being governed by the penetration depth of the skin effect. For electromagnetic radiation in the frequency range above 10 Mbit/s, the penetration depth is in the μm range, so that wire thicknesses of more than 50 μm ensure that electromagnetic interference radiation is suppressed by more than 30 dB.

In one preferred refinement, a spacer is integrated into the front surface of the wire mesh. The spacer prevents electrical connection of the wire mesh and the contact pins of the leadframe even when they—as is frequently done—are designed to be curved in the area of the connection to a circuit board. In consequence, it is possible to continue the shielding on the front face of the wire mesh as far as the circuit mount.

The present invention also provides two methods by means of which an optoelectronic apparatus with an integrated shielding plate can be produced.

According to a first method, the transducer component is first of all arranged on a leadframe, and electrical contact is made with the transducer component on the leadframe in a manner which is known per se. A wire mesh is provided, which is curved such that it forms a structure which is open on at least one side. For this purpose, the wire mesh has, for example, a front face and at least one side area which projects essentially at right angles from the front face. The wire mesh is now connected to at least one ground contact of the leadframe, with an open face of the structure of the wire mesh being closed by the leadframe. This results in a shielding cage in which the transducer module is located.

The leadframe is now inserted with the wire mesh hanging downwards into a mold, which is preferably a die-casting mold or an injection-molding mold. An encapsulation material is introduced into the mold. Once the encapsulation material is cured, it forms a housing which contains the leadframe with the transducer component. In particular, the wire mesh is also completely embedded in the housing. This results in a shielding structure which is permanently integrated in the housing and directly surrounds the transducer component.

In this case, it should be mentioned that the ground pin of the leadframe may normally have two or more branches and in this case produces a large number of ground contacts, to each of which the wire mesh can be attached at points. The branching structure of the ground contacts is in this case preferably sufficiently robust that the individual ground contacts are not bent, or are bent only insignificantly, during the insertion of the leadframe, with the wire mesh hanging downwards, into a mold. This avoids the risk of undesirable contact between the wire mesh and bonding wires on the leadframe.

In a second method, the transducer component is once again arranged on the leadframe, where electrical contact is made with it. In this case, the transducer component (in the method mentioned above as well) can be arranged on the leadframe by means of a mount element (submount). A wire mesh which spreads out in a planar fashion is then provided, and is partially inserted into the mold. The leadframe together with the transducer component is likewise introduced into the mold, to be precise at a distance from the wire mesh. An encapsulation material is now introduced into the mold, where it is cured. The cured encapsulation material forms a housing for the apparatus, with the wire mesh being partially embedded in the housing. Once the encapsulation material is cured, those areas of the wire mesh which are arranged at the side of the housing are bent around in the direction of the leadframe, and at least one bent-around area is at least partially connected to at least one ground contact of the leadframe, forming a shielding cage.

In both methods, the optoelectronic apparatus is preferably produced in blanks on a multinest tool, with the individual optoelectronic apparatuses in the multinest tool being separated once the encapsulation material has cured. In particular, the second method preferably provides for the individual apparatuses in the multinest tool to be separated after the encapsulation process, with the wire mesh in this case being cut through in the area between the individual apparatuses, thus providing areas of the wire mesh which are arranged at the side of the housing and which can be bent around in the direction of the leadframe.

### BRIEF DESCRIPTION OF THE FIGURES

The invention will be explained in more detail in the following text on the basis of a number of exemplary embodiments and with reference to the figures, in which:

FIG. 1a shows a front view of one exemplary embodiment of an optoelectronic apparatus with a transmission component and a shielding cage;

FIG. 1b shows a front view of one exemplary embodiment of an optoelectronic apparatus with a receiving component and a shielding cage;

FIG. 1c shows a side view of an apparatus as shown in FIG. 1a or FIG. 1b;

FIG. 2 shows a partially sectioned view of an arrangement with a base part of an injection-molding apparatus or die-casting apparatus and a leadframe which has been introduced into the injection-molding apparatus or die-casting apparatus, as well as a laser chip arranged on the leadframe;

FIG. 3 shows a partially sectioned view of an arrangement with a base part of an injection-molding apparatus or die-casting apparatus, a leadframe which has been introduced into the injection-molding apparatus or die-casting apparatus, and a photodiode chip which has been arranged on the leadframe;

FIG. 4a shows a leadframe with components arranged on it, as well as a wire mesh;

FIG. 4b shows a side view of the arrangement shown in FIG. 4a, and

FIG. 4c shows a side view of the arrangement shown in FIG. 4a, with the leadframe and the components arranged on the leadframe being sheathed with a transparent encapsulation material.

### DESCRIPTION OF A NUMBER OF PREFERRED EXEMPLARY EMBODIMENTS

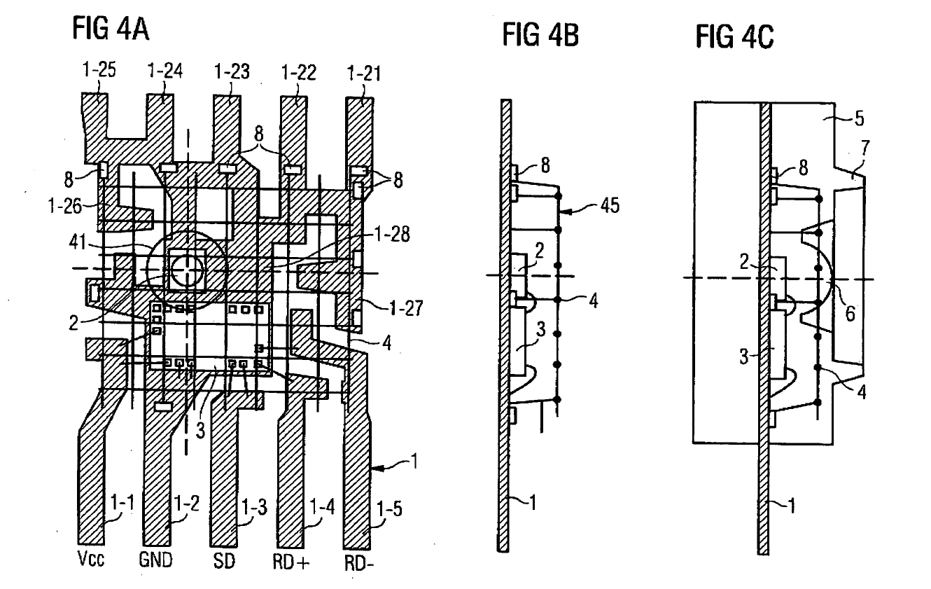

In order to assist understanding of the invention, the initial situation to which the invention relates will first of all be described with reference to FIGS. 4a and 4b.

As is shown in FIGS. 4a and 4b a receiving component 2 (which is in the form of a photodiode chip) and an electrical component 3 (which is associated with it) and is, for example a preamplifier IC, are arranged on a leadframe. The leadframe has a number of pins 1-1, 1-2, 1-3, 1-4, 1-5. The operating voltage V_{CC} is provided via the pin 1-1, the ground contact via the pin 1-2, the signal SD (SD=Signal Detect) via the pin 1-3, and the differential received signal RD+, RD− via the pins 1-4 and 1-5.

The ground pin 1-2, which is also referred to as the ground lead 1-2, branches to a contact surface 1-28 for the components 2, 3 which are arranged on the leadframe 1, and to a large number of ground arms 1-21, 1-22, 1-23, 1-24, 1-25, 1-26, 1-27.

Contact is made with the photodiode chip 2 and with the preamplifier IC 3 via the ground lead 1-2 and via bonding wires which originate from the other leads.

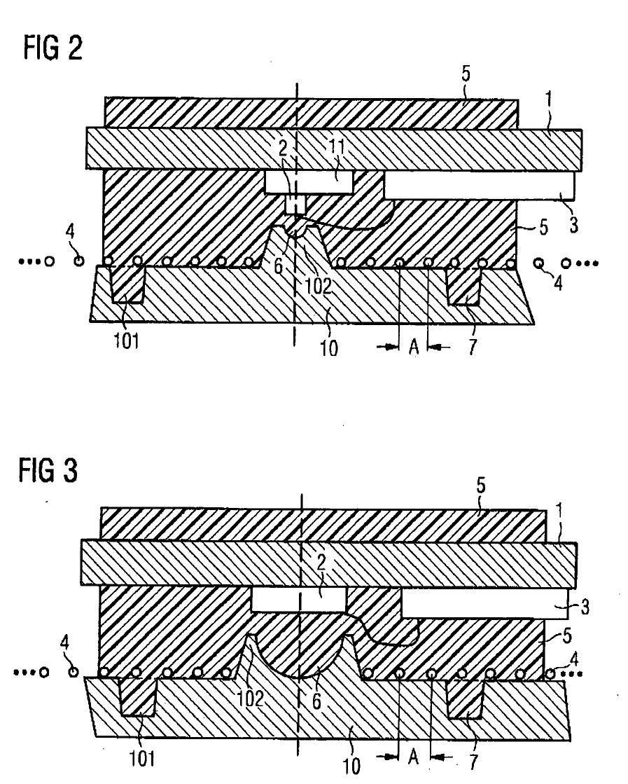

A transmission module with a laser diode chip 2 arranged on the leadframe 1 is formed in a corresponding manner. A laser diode chip 2 in this case has an associated driver IC, as an electrical component 3. The laser diode chip 2 is preferably not arranged directly on the leadframe 1, but on a mount element or submount 11 which is in turn connected to the leadframe 1. A corresponding arrangement is illustrated in FIG. 2. When using a photodiode chip, as well, this may be connected to the leadframe 1 via a submount.

It is desirable to provide as high a degree of shielding as possible for the radio-frequency electromagnetic radiation which is emitted from a laser chip. It is likewise desirable to protect a photodiode chip as effectively as possible against electromagnetic interference radiation, in order to keep the signal detection process free of interference signals.

For this purpose, provision is made for a wire mesh to be integrated in the apparatus and to be connected to the leadframe 1, with the leadframe 1 and the wire mesh forming a shielding cage, in which the optoelectronic transducer component 2 is located. A first exemplary embodiment of an arrangement such as this is illustrated in Figures la to 3, and a second exemplary embodiment of an arrangement such as this is illustrated in FIGS. 4a to 4c.

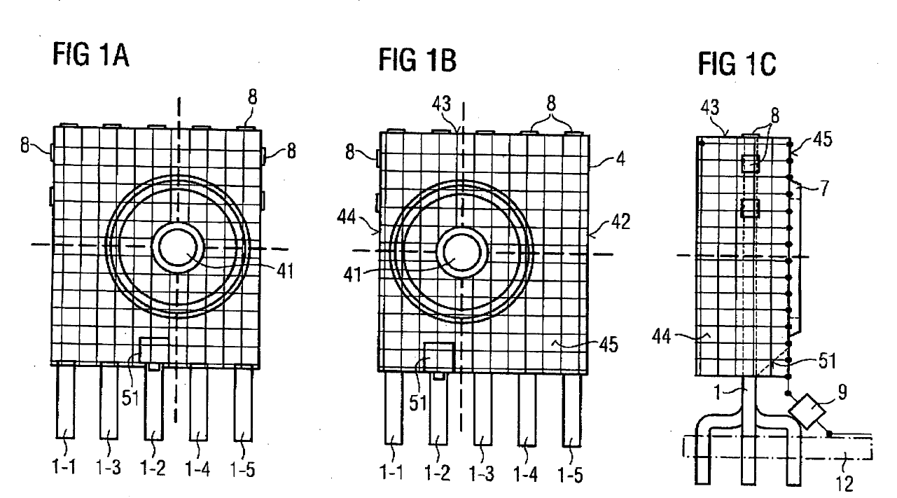

According to the arrangement shown in FIGS. 1a to 1c, a fine-mesh wire mesh 4 is provided and is bent such that it has a front face 45, which is separated from the leadframe 1, and side areas 42, 43, 44 which project from the front face 45 at an angle of essentially 90°. Two of the side areas are in this case respectively formed on the right face and on the left face, and one of the side areas 43 is formed on the upper face. On the lower face, the wire mesh is not bent in the direction of the leadframe 1, in order to avoid undesirable contact with the other leads 1-1, 1-3, 1-4, 1-5 of the leadframe.

On its side areas 41, 42, 43, the wire mesh 4 is connected at junction points 8 to individual ground arms of the ground lead 1-2 (corresponding to the ground arms 1-21 to 1-27 in FIG. 4a).

It should be mentioned that the wire mesh may extend beyond the leadframe 1 as is illustrated in FIG. 1c. This is possible, but is in no way necessary. The essential feature is the link to the ground contact of the leadframe, so that the leadframe 1 and the wire mesh 4 together form a shielding cage for the transducer component 2 which is arranged on the leadframe 1.

One preferred refinement provides for a non-conductive spacer 9 to be integrated in the wire mesh on the front face 45, to be precise in the area which projects downwards in the direction of a circuit board or printed circuit board 12. A spacer 9 such as this ensures that the area of the wire mesh on the front face 45 which projects downwards cannot make contact with the pins 1-2, 1-3, 1-4, 1-5 of the leadframe even when, as is illustrated in FIG. 1c, these are partially bent in order to form a more robust arrangement on the associated circuit board 12.

The wire mesh 4 is in each case connected to the leadframe 1 at points, that is to say attachment points 8. As is evident from FIG. 1c, this results in an essentially closed shielding cage in which the transducer component 2 is located.

Particularly good shielding is provided by the large number of contacts and junction points 8 between the shielding mesh 4 and the ground lead 1-2. Furthermore a reliable structural connection is produced between the wire mesh 4 and the leadframe 1 via the large number of junction points 8.

As already mentioned, the wire mesh is connected to the leadframe 1 on as many sides as possible via as many junction points 8 as possible. In the refinement shown in Figure la, a connection is made to the earth leads of the leadframe on three sides. In the refinement shown in FIG. 1b, a contact such as this is made on two sides. As mentioned, the wire mesh 4 is not bent around downwards in the direction of the leadframe, in the direction of the circuit board 12 (see FIG. 1c) on which the module is arranged since, otherwise, there would be a risk of contact with the other leads 1′1, 1′3, 1′4, 1′5 of the leadframe. However, there is an incline 51 on the front face of the plastic housing of the apparatus, which also allows the front face 45 of the wire mesh 4 to be connected to the ground pin 1-2 in a lower area.

In the area of the front face 45, the wire mesh 4 is embedded in the plastic housing by means of which the leadframe 1 and the components 2, 3 arranged on it are sheathed. The production method will be explained in detail in the following text with reference to FIGS. 2 and 3.

However, first of all, it should once again be mentioned that the wire mesh 4 forms a small opening 41 in the optical window, via which signals are injected into and output from the module. However, the opening 41 in the wire mesh 4 is reduced to a minimum, so that the shielding behavior is influenced as little as possible by the opening 41.

The production of the module as shown in FIGS. 1a to 1c, the formation of an optical functional surface 6 in the housing, and the embedding of the wire mesh, will be explained in the following text with reference to FIGS. 2 and 3.

FIG. 2 shows the production of an optical apparatus with a transmission component 2, which is arranged on the leadframe 1 above a submount 11. A driver IC 3 is also provided on the leadframe 1.

The leadframe 1 together with the components 2, 3, 11 already mounted on it is introduced into an injection-molding apparatus or die-casting apparatus, of which the base part 10 is illustrated. The base part has a circular cutout 101 in order to form an adjusting ring, and has a projecting structure 102 in order to form an optical functional surface, specifically a lens 6.

A wire mesh 4, which is still in a planar form is placed onto the base part 10 of the injection-molding apparatus or die-casting apparatus. The wire mesh 4 is continuous, except for an opening in the area of the projecting structure 102 of the base part 10. As indicated, the wire mesh 4 in this case extends beyond the edge of the base part 10. Provision is in this case generally made for the components to be formed in the blank on a multinest tool. A continuous wire mesh 4 is then used, and is placed onto a large number of base parts 10.

FIG. 2 also illustrates the mesh width A of the wire mesh. The mesh width is preferably in the range between 50 and 500 μm.

The upper part of the injection-molding mold or die-casting mold is not illustrated.

The transparent housing 5 is produced once the transparent plastic, which has been introduced into the injection-molding apparatus or the die-casting apparatus, has been introduced and cured. This forms the functional surface 6 and the adjusting ring 7 in an integrated manner. Furthermore, a part of the wire mesh 4 is embedded and integrated in the injection-molding or die-casting part.

Once the respective modules have been separated, the wire mesh which projects at the side is bent around in order to form the side areas 42, 43, 44 as shown in FIGS. 1a, 1b, 1c. It is then attached to the individual ground leads of the leadframe 1-2, forming an electromagnetic shielding cage in which the transmission component 2 is located.

The projecting adjusting ring 7 can be seen in the illustration from the side in FIG. 1c.

FIG. 3 shows a base part 10 of an injection-molding tool or a die-casting tool, and a leadframe 1, which has been introduced into an injection-molding tool or die-casting tool such as this, with a photodiode chip 2 and a preamplifier IC 3, that is to say for the case of a receiving device. What has been stated with regard to FIG. 2 applies in a corresponding manner to the production method. The only difference is that on the one hand, the photodiode chip 2 is not arranged above a submount, but directly on the leadframe 1.

Alternatively, however, an arrangement can also be provided above a submount on the leadframe 1. A second difference is that the lens 6 which is integrated in the plastic body 5 is considerably larger, in order to optimally focus incident light on the photo-sensitive surface of the photodiode chip 2.

FIGS. 4a to 4c show a second embodiment variant relating to the production of a shielding cage with an integrated wire mesh.

According to this embodiment variant, the wire mesh 4 is connected to the leadframe 1 before being introduced into an injection-molding tool or die-casting tool and before being sheathed with a transparent injection-molding or die-casting substance. The wire mesh is in this case once again bent in order to produce a front face 45 and a number of side areas. The wire mesh is open towards the leadframe 1. The side areas of the wire mesh 4 are now connected to the individual frames 1-21 to 1-27 of the ground lead 1-2 at attachment points 8. For example, it is soldered at points to the arms of the ground lead. The individual arms 1-21 to 1-27 of the ground lead are in this case sufficiently robust not to bend in an undesirable manner after attachment of the wire mesh.

This results in a shielding cage whose rear face is formed by the leadframe 1 itself.

Once the wire mesh 4 has been fitted to the leadframe 1, the leadframe 1 and the wire mesh 4 are introduced into an injection-molding apparatus or die-casting apparatus as is shown in FIGS. 2 and 3, with the wire mesh 4 hanging downwards. Finally, this is extrusion-coated with a transparent injection-molding or die-casting substance, resulting in the plastic housing 5, as illustrated in FIG. 4c, with an integrated lens and an integrated adjusting ring 7. In this refinement, the wire mesh 4 is completely integrated in the housing 5. Thus, in contrast to the illustration in FIGS. 1a to 1c, the areas of the wire mesh 4 which project at the side after the injection-molding or die-casting process are not bent around in the direction of the leadframe. This is completely integrated in the housing 5.

The embodiment of the invention is not restricted to the exemplary embodiments described above. For example, it is obvious to the person skilled in the art that the precise way in which the wire mesh is connected to the leadframe is not significant. All that is important is that a wire mesh is integrated in the apparatus and in this case, together with a leadframe to which the transducer module is particular forms an electromagnetic shielding cage.

1. An optoelectronic apparatus comprising:
at least one optoelectronic transducer component,
a leadframe on which the transducer component is arranged,
a housing which at least partially surrounds the transducer component, and
a wire mesh, with
the wire mesh being at least partially embedded in the housing, and
being connected to at least one ground contact of the leadframe, the wire mesh forming a shielding cage in which the transducer component is located.

2. The apparatus as claimed in claim 1, wherein the wire mesh comprises an opening in an area of an optical window in the transducer component.

3. The apparatus as claimed in claim 2, wherein the housing comprises an optical functional surface in the area of the optical window in the transducer component, and the opening of the wire mesh is formed in the area of the optical functional surface.

4. The apparatus as claimed in claim 1, wherein the wire mesh comprises a front face, which is at a distance from the leadframe, and at least one side area which extends substantially at right angles to a front face in the direction of the leadframe.

5. The apparatus as claimed in claim 4, wherein the wire mesh is electrically connected on at least one side area to at least one ground contact of the leadframe.

6. The apparatus as claimed in claim 4, wherein the front face of the wire mesh is connected to a ground contact of the leadframe, and wherein the housing forms an incline to accommodate the connection.

7. The apparatus as claimed in claim 1, further comprising a non-conductive spacer integrated in the wire mesh on a front face adjacent to a plurality of contact pins of the leadframe.

8. The apparatus as claimed in claim 1, further comprising an electrical component associated with the optoelectronic transducer component additionally arranged on the leadframe.

9. The apparatus as claimed in claim 1, wherein the transducer component is arranged on a mount element, and the mount element is arranged on the leadframe.

10. The apparatus as claimed in claim 1, wherein a diameter of a wire of the wire mesh is at least 30 μm.

11. The apparatus as claimed in claim 1, wherein a mesh width of the wire mesh is between about 50 and 500 μm.

12. The apparatus as claimed in claim 1, wherein the wire mesh comprises copper wire or aluminum wire.

13. The apparatus as claimed in claim 1, wherein the at least one transducer component comprises a transmission component or a receiving component.

14. The apparatus as claimed in claim 13, wherein the apparatus comprises an optoelectronic transceiver comprising a transmission component and a receiving component.

15. The apparatus as claimed in claim 1, wherein the housing comprises a plastic housing comprising an encapsulation material.

16. A method for production of an optoelectronic apparatus with an integrated shielding cage, comprising:
arranging a transducer element on a leadframe,
making electrical contact between the leadframe and the transducer component,
providing a wire mesh, which is curved such that it forms a structure which is open on at least one side,
connecting the wire mesh to at least one ground lead of the leadframe, with an open face of the wire mesh being closed by the leadframe forming a shielding cage,
inserting the leadframe, with the wire mesh hanging downwards, into a mold, and
introducing an encapsulation material into the mold, wherein
the cured encapsulation material forms a housing for the optoelectronic apparatus, and
the wire mesh is embedded in the housing.

17. The method as claimed in claim 16, further comprising forming an optical functional surface in the housing during the introduction of the encapsulation material into the mold.

18. The method as claimed in claim 17, wherein the wire mesh comprises an opening, and wherein the wire mesh is positioned in the mold such that the opening is located in the area of the optical functional surface.

19. A method for production of an optoelectronic apparatus with an integrated shielding cage, comprising:
arranging a transducer component on a leadframe,
making electrical contact between the leadframe and the transducer component,
providing a wire mesh which is spread out in a planar fashion,
partially inserting the wire mesh into a mold,
introducing the leadframe together with the transducer component into the mold at a distance from the wire mesh,
introducing an encapsulation material into the mold, with the cured encapsulation material forming a housing for the optoelectronic apparatus, and the wire mesh being partially embedded in the housing,
after curing of the encapsulation material, bending areas of the wire mesh arranged at a side of the housing in the direction of the leadframe,
connecting at least one bent-around area of the wire mesh to at least one ground contact of the leadframe, thereby forming a shielding cage.

20. The method as claimed in claim 19, further comprising forming an optical functional surface in the housing during the introduction of the encapsulation material into the mold.

21. The method as claimed in claim 20, wherein the wire mesh comprises an opening, and wherein the wire mesh is positioned in the mold such that the opening is located in the area of the optical functional surface.

22. The method as claimed in claim 19, wherein the apparatus is produced on a multinest tool, wherein the individual apparatuses are separated from the multinest tool after the encapsulation process, and wherein the wire mesh is cut through during the separation process in an area between the individual apparatuses, as a result of which areas of the wire mesh which are arranged at a side of the housing are made available, and are bent in the direction of the leadframe.
